(19) United States
(12) Patent Application Publication
(10) Pub. No.: US 2016/0133155 A1
(43) Pub. Date: May 12, 2016

(54) APPARATUS FOR LEARNING VOWEL REDUCTION AND METHOD FOR SAME

(71) Applicant: POSTECH ACADEMY-INDUSTRY FOUNDATION, Pohang-si, Gyeongsangbuk-do (KR)

(72) Inventors: Geun Bae LEE, Pohang-si, Gyeongsangbuk-do (KR); Se Chun KANG, Gimhae-si, Gyeongsangnam-do (KR); Jee Soo BANG, Pohang-si, Gyeongsangbuk-do (KR); Kyu Song LEE, Seoul (KR)

(73) Assignee: Postech Academy-Industry Foundation, Pohang-si, Gyeongsangbuk-do (KR)

(21) Appl. No.: 14/897,903

(22) PCT Filed: May 8, 2014
(86) PCT No.: PCT/KR2014/004101

§ 371 Date: Dec. 11, 2015

(30) Foreign Application Priority Data
Jun. 13, 2013 (KR) 10-2013-0067678

(51) Int. Cl. G09B 19/06; G10L 15/02

(52) U.S. Cl. CPC G09B 19/06; G10L 15/02; G10L 2015/025

(57) ABSTRACT

Disclosed are an apparatus and a method for providing analysis information on vowel reduction. An apparatus for learning vowel reduction comprises: a vowel reduction predicting unit extracting text characteristics information including predicted pronunciation and predicted stress information related to a word in a text, through prediction of the text, and generating vowel reduction information of the text based on a pre-saved vowel reduction prediction model DB, by using the text characteristics information; a vowel reduction detection unit extracting speech characteristics information including detected pronunciation and detected stress information, by analyzing a speech of a user corresponding to the text, and generating vowel reduction information of the speech based on a pre-saved vowel reduction detection model DB, by using speech characteristics; and a vowel reduction feedback unit for generating and providing vowel reduction difference information by comparing the vowel reduction information of the text and vowel reduction information of the speech.

### BACKGROUND

1. Field

The present disclosure relates to a foreign language learning, more particularly to apparatuses for providing analysis information on vowel reduction and methods for the same.

2. Description of Related Art

In modern societies being globalized, knowledge of foreign languages is necessarily demanded. Accordingly, fevers for learning foreign languages such as English and Chinese are increasing.

However, off-line foreign language education performed by skilled persons requires time, cost, and spaces for it. In order to substitute the high-cost foreign language educations, studies on foreign language learning based on computer systems are going on.

Especially, a computer-assisted pronunciation training (CAPT) system using a computer in the learning of foreign language pronunciation is being developed.

Also, studies on methods for extracting and evaluating pronunciation from spontaneous speeches of users by including a speech recognizer in the CAPT system under a situation that a target text is not provided are being progressed. However, even in the system using the high-performance speech recognizer, it is difficult to exactly extract and evaluate pronunciation for a specific pronunciation combined with rhythm elements.

For example, in English, ‘schwa (e.g., /∂/)’ may be referred to as a representative pronunciation which should be realized based on understanding of rhythm elements. That is, most of vowels on which stresses are not given are pronounced shortly and weakly (i.e., phenomenon of vowel reduction). Therefore, in order to exactly pronounce English words, it is necessary to train the vowel reduction. However, it is difficult to efficiently train the vowel reduction in the English pronunciation.

### SUMMARY

An aspect of exemplary embodiments is to provide an apparatus for learning vowel reduction which can increase effects of foreign language learning by providing feedbacks of vowel reduction to users.

Another aspect of exemplary embodiments is to provide a method for learning vowel reduction which can increase effects of foreign language learning by providing feedbacks of vowel reduction to users.

According to an aspect of exemplary embodiments of the present disclosure, an apparatus for learning vowel reduction is provided. The apparatus may comprise a vowel reduction predicting unit extracting text characteristics information including predicted pronunciation and predicted stress information related to words in a text through prediction on the text, and generating vowel reduction information of the text based on a pre-saved vowel reduction prediction model database (DB), by using the text characteristics information; a vowel reduction detection unit extracting speech characteristics information including detected pronunciation and detected stress information based on an analysis on a speech of a user corresponding to the text, and generating vowel reduction information of the speech based on a pre-saved vowel reduction detection model DB, by using the speech characteristics information; and a vowel reduction feedback unit generating vowel reduction difference information by comparing the vowel reduction information of the text and the vowel reduction information of the speech.

Here, the vowel reduction predicting unit may comprise a pronunciation prediction module generating the predicted pronunciation by predicting pronunciation of words included in the text based on a pronunciation dictionary DB; and a stress prediction module generating the predicted stress information by predicting stresses of words included in the text.

Also, the vowel reduction predicting unit may further comprise a vowel reduction prediction module obtaining prediction information corresponding to the text characteristics information from the pre-saved vowel reduction prediction model DB, and generating the vowel reduction information of the text by using the obtained prediction information.

Here, the vowel reduction detection unit may comprise a pronunciation recognition module generating the detected pronunciation by detecting actual phonemes of the speech of the user based on an extended pronunciation dictionary DB; and a stress detection module generating the detected stress information by detecting stresses of words included in the speech of the user.

Also, the vowel reduction detection unit may further comprise a vowel reduction detection module obtaining detection information corresponding to the speech characteristics information from the pre-saved vowel reduction detection model DB, and generating the vowel reduction information of the speech by using the obtained detection information.

Here, the vowel reduction feedback unit may comprise a vowel reduction comparison module generating vowel reduction difference information by comparing the vowel reduction information of the text and the vowel reduction information of the speech; and a vowel reduction feedback module generating certainty information of the vowel reduction difference information, and providing the vowel reduction difference information when the certainty information meets a predetermined threshold.

Also, the vowel reduction feedback module may generate the certainty information by summing a probability according to the vowel reduction information of the text and a probability according to the vowel reduction information of the speech, respective weights being applied to the probabilities.

Here, the text characteristics information may be extracted from a text vowel reduction corpus DB in which vowel reductions are labeled, and a distribution and a weight of a probability that a vowel reduction occurs are stored in the pre-saved vowel reduction prediction model DB through a machine-based learning using the text characteristics information as training data.

Here, the speech characteristics information may be extracted from a speech vowel reduction corpus DB in which vowel reductions are labeled, and a distribution and a weight of a probability that a vowel reduction occurs are stored in the pre-saved vowel reduction prediction model DB through a machine-based learning using the text characteristics information as training data.

According to another aspect of exemplary embodiments of the present disclosure, a method for learning vowel reduction is provided. The method may comprise extracting text characteristics information including predicted pronunciation and predicted stress information related to words in a text through prediction on the text, and generating vowel reduction information of the text based on a pre-saved vowel reduction prediction model database (DB), by using the text characteristics information; extracting speech characteristics information including detected pronunciation and detected stress information based on an analysis on a speech of a user corresponding to the text, and generating speech vowel reduction information of the speech based on a pre-saved vowel reduction detection model DB, by using the speech characteristics information; and generating and providing vowel reduction difference information by comparing the vowel reduction information of the text and the vowel reduction information of the speech.

The apparatus and method for learning vowel reduction according to the above-described exemplary embodiments may compare correct vowel reductions of a provided text and vowel reductions included in a user speech corresponding to the provided text, and support efficient foreign language learning of the user by providing the user with information corresponding to a difference between the correct vowel reductions of the text and the vowel reductions included in the user speech.

Also, the information corresponding to the difference may be provided based on certainty of the information thereby increasing the reliability of the information.

### BRIEF DESCRIPTION OF DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a block diagram to explain an apparatus for learning vowel reductions according to an exemplary embodiment of the present disclosure;

FIG. 2 is a block diagram of a vowel reduction prediction model DB according to an exemplary embodiment;

FIG. 3 is a block diagram of a vowel reduction detection model DB according to an exemplary embodiment;

FIG. 4 is a conceptual diagram to explain provision of vowel reduction difference information according to an exemplary embodiment of the present disclosure; and

FIG. 5 is a flow chart to explain a method for learning vowel reductions according to an exemplary embodiment of the present disclosure.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the apparatuses and methods for learning vowel reductions according to exemplary embodiments of the present disclosure may be implemented in at least one server or by using at least one server. Also, they may be implemented as including at least one server and a plurality of user terminals.

The at least one server and the plurality of user terminals may be connected directly, or interconnected through wireless or wired networks. Here the server may be a web server, etc., and the user terminal may be a various type of terminal, which can communicate with the server, and is equipped with information processing capability, such as a portable multimedia player (PMP), a laptop computer, a TV, a smart phone, and a pad-type terminal.

Hereinafter, preferred exemplary embodiments according to the present disclosure will be explained in detail by referring to accompanying figures.

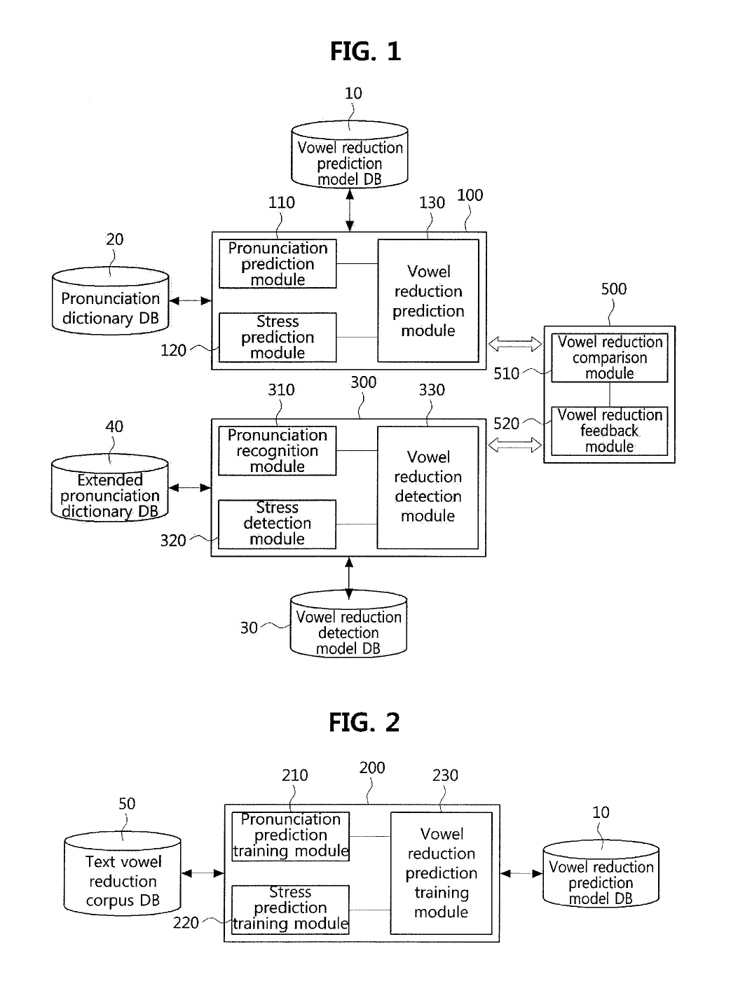

FIG. 1 is a block diagram to explain an apparatus for learning vowel reductions according to an exemplary embodiment of the present disclosure.

Referring to FIG. 1, the apparatus for learning vowel reductions according to an exemplary embodiment of the present disclosure may be configured to comprise a vowel reduction predicting unit 100, a vowel reduction detection unit 300, and a vowel reduction feedback unit 500. Also, the apparatus may interwork with a vowel reduction prediction model data base (DB) 10, a pronunciation dictionary DB 20, a vowel reduction detection model DB 30, and an extended pronunciation dictionary DB 40.

The apparatus may predict vowel reductions in a provided text, and detect vowel reductions in a speech of a user that corresponds to the provided text. Also, the apparatus may compare the predicted vowel reductions with the detected vowel reductions, and help the user to efficiently learn vowel reductions of a foreign language by providing information on differences between the predicted vowel reductions and the detected vowel reductions.

The vowel reduction predicting unit 100 may extract text characteristics information including predicted pronunciation and predicted stress information related to words in the provided text through prediction on the provided text. Here, the predicted vowel reductions may be represented as vowel reduction information of the text.

Also, the vowel reduction predicting unit 100 may generate vowel reduction information of the text based on a pre-saved vowel reduction prediction model DB 10, by using the text characteristics information. Here, the pre-saved vowel reduction prediction model DB 10 may be constructed by a vowel reduction prediction training unit 200 of FIG. 2 which will be explained.

Specifically, the vowel reduction predicting unit 100 may comprise a pronunciation prediction module 110, a stress prediction module 120, and a vowel reduction prediction module 130.

The pronunciation prediction module 110 may generate the predicted pronunciation by predicting the pronunciation of the words included in the provided text based on the pronunciation dictionary DB 20, and the stress prediction module 120 may generate the predicted stress information by predicting the stress of the words in the text.

For example, the pronunciation prediction module 110 may extract pronunciation phonemes corresponding to the respective words of the provided text from the pronunciation dictionary DB 20. When a word has various pronunciations, it may calculate Levenshtein edit distances between actual phonemes which are pronunciation phonemes detected by a pronunciation recognition module 310 and the various pronunciations, and select a pronunciation having the shortest distance among the various pronunciations as the predicted pronunciation.

The stress prediction module 120 may predict stresses of respective words included in the text by analyzing the text, and represent them as the predicted stress information. That is, the stresses may be predicted by calculating probabilities of that a stress exists in respective words.

Also, the vowel reduction prediction module 130 may obtain prediction information corresponding to text characteristics information including the predicted pronunciation and the predicted stress information from the pre-saved vowel reduction prediction model DB 10, and generate vowel reduction information of the text by using the obtained prediction information.

Specifically, the vowel reduction prediction module 130 may obtain stress information on regular phonemes and respective words, which is extracted from the dictionary prediction module 110 and the stress prediction module 120, that is, a probability and weight of that a vowel reduction corresponding to the text characteristics information occurs, from the pre-saved vowel reduction prediction model DB 10, and generate the vowel reduction information of the text by performing weighted summing of the probabilities and the weights and predicting the vowel reduction of the text.

Also, prediction of vowel reduction for a specific word in the text comprising words may be performed by weighted-summing weight values representing a probability that a reduction phenomenon occurs to a vowel of the specific word and a probability that a reduction phenomenon occurs to a vowel of the specific word according to characteristics of respective words, in consideration of effects which the vowel reduction of the specific word affects vowel reductions of outputs of respective modules for respective words.

For example, the text characteristics information may include stress probabilities of respective words included in the text, vowel phonemes of the words, information on the order of the vowel phoneme in the word, etc.

Also, in order to predict the vowel reduction, a Nave Bayesian classifier, an inductive decision-tree classifier, or a neural network classifier, which is a machine-learning based classifier, may be used.

The vowel reduction detection unit 300 may extract speech characteristics information including detected pronunciation and detected stress information based on an analysis on a speech of a user corresponding to the provided text. Also, the vowel reduction prediction unit 300 may generate vowel reduction information of the speech by using the speech characteristics based on a pre-saved vowel reduction detection model DB 30. Here, the detected vowel reduction may be represented as the vowel reduction information of the speech.

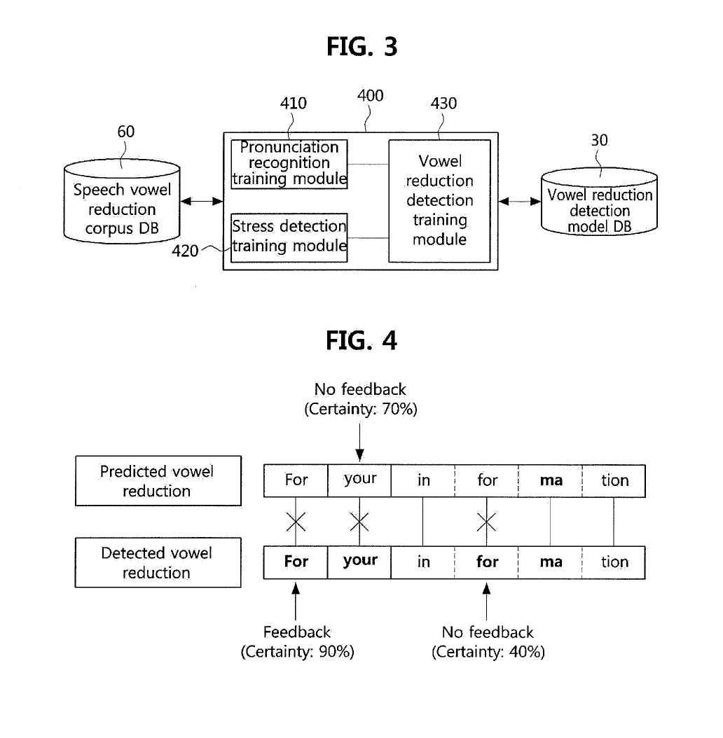

The vowel reduction detection unit 300 may extract the speech characteristics information for detecting vowel reductions in the speech of the user corresponding to the provided text, and obtain detection information corresponding to the speech characteristics information from the pre-saved vowel reduction detection model DB 30. Thus, the vowel reduction detection unit 300 may generate the vowel reduction information of the speech by detecting vowel reductions from the speech according to the speech characteristics information. Here, the pre-saved vowel reduction detection model DB 30 may be constructed by a vowel reduction detection training unit 400 of FIG. 3 which will be explained.

Specifically, the vowel reduction detection unit 300 may comprise a pronunciation recognition module 310, a stress detection module 320, and a vowel reduction detection module 330.

The pronunciation recognition module 310 may generate the detected pronunciation by detecting actual phonemes of the speech of the user based on the extended pronunciation dictionary DB 40, and the stress detection module 320 may generate the detected stress information by detecting stresses of the words included in the speech of the user.

The pronunciation recognition module 310 may recognize the speech to generate corresponding pronunciation phonemes. That is, the detected pronunciation may mean the actual phonemes extracted by recognizing the speech.

The stress detection module 320 may analyze the speech to detect the stresses of respective words in the text, and represent them as the detected stress information. Here, the stresses may be detected by calculating probabilities that stresses are given to respective words.

Thus, the speech characteristics information may include the actual phonemes of the pronunciation generated by analyzing the speech and the information on probabilities of the stresses of the respective words forming the speech.

Also, the vowel reduction detection module 330 may obtain the detection information corresponding to the speech characteristics information including the detected pronunciation and the detected stress information from the pre-saved vowel reduction detection model DB 30, and generate the vowel reduction information of the speech by using the obtained detection information.

The vowel reduction detection module 330 may use the stress information on the actual phonemes and respective words generated in the pronunciation recognition module 310 and the stress detection module 320 to detect the vowel reduction of the speech corresponding to the text.

Also, in order to detect the vowel reduction, a Nave Bayesian classifier, an inductive decision-tree classifier, or a neural network classifier, which is a machine-learning based classifier, may be used.

Furthermore, the detection of vowel reduction for a specific word in the text comprising words may be performed by weighted-summing weight values representing a probability that a reduction phenomenon occurs to a vowel of the specific word and a probability that a reduction phenomenon occurs to a vowel of the specific word according to characteristics of respective words, in consideration of effects which the vowel reduction of the specific word affects vowel reductions of outputs of respective modules for respective words.

The vowel reduction feedback unit 500 may generate vowel reduction difference information by comparing the vowel reduction information of the text and the vowel reduction information of the speech.

That is, the vowel reduction feedback unit 500 may compare the vowel reduction information of the text which is predicted by the vowel reduction predicting unit 100 and the vowel reduction information of the speech which is detected by the vowel reduction detection unit 300 to obtain the difference between them.

Also, the vowel reduction feedback unit 500 may provide the vowel reduction difference information to the user when a certainty of the vowel reduction difference information meets a preconfigured threshold.

Specifically, the vowel reduction feedback unit 500 may comprise a vowel reduction comparison module 510 and a vowel reduction feedback module 520. The vowel reduction comparison module 510 may generate the vowel reduction difference information through the comparison between the vowel reduction information of the text and the vowel reduction information of the speech, and the vowel reduction feedback module 520 may generate the certainty information of the vowel reduction difference information, and provide the vowel reduction difference information when the certainty information meets the preconfigured threshold.

Here, the vowel reduction feedback module 520 may generate the certainty information by respectively applying weights to probabilities according to the vowel reduction information of the text and probabilities according to the vowel reduction information of the speech.

For example, the vowel reduction comparison module 510 may compare vowels of words constituting the text and vowels constituting the pronunciation.

Also, the vowel reduction feedback module 520 may perform weighted-summing of a probability p1 predicted when a vowel reduction exists in the text and a probability p2 detected when a vowel reduction exists in the speech thereby generating the certainty information of the vowel reduction difference information. Through this, the vowel reduction feedback module 520 may provide the vowel reduction difference information to the user only when the certainty information meets the predetermined threshold.

In other words, the certainty information may be calculated for maintaining reliability of the feedback, and be controlled to be provided to the user only when the certainty meets the predetermined threshold so that the user can have trust in the feedback.

More specifically, when a difference exists between the predicted vowel reduction of the text and the detected vowel reduction of the speech, the feedback may not be performed. Only when the certainty information meets the predetermined threshold, the vowel reduction difference information may be provided to the user as the feedback.

For example, in a case that the predetermined threshold is 90%, the feedback may be provided to the user only when the calculated certainty information is equal to or greater than 90%. Also, the predetermined threshold may be configured variously according to a variety of situations in which the apparatus according to the present disclosure is used.

Here, the vowel reduction difference information is the information which can be used for the user to identify the difference between the predicted vowel reduction and the detected vowel reduction, and may be provided to the user as visual or audible information.

FIG. 2 is a block diagram of a vowel reduction prediction model DB according to an exemplary embodiment.

Referring to FIG. 2, the vowel reduction prediction model DB 10 may be constructed by a vowel reduction prediction training unit 200. Thus, the apparatus for learning vowel reduction according to an exemplary embodiment may further comprise the vowel reduction prediction training unit 200.

The vowel reduction prediction training unit 200 may extract features for predicting vowel reduction from a text corpus stored in a text vowel reduction corpus DB 50, in which vowel reductions are labeled, and store a distribution or a weight of a probability that a vowel reduction occurs, which are generated through the machine-based learning using the extracted features as training data, in the vowel reduction prediction model DB 10.

Specifically, the vowel reduction prediction training unit 200 may comprise a pronunciation prediction training module 210, a stress prediction training module 220, and a vowel reduction prediction training module 230.

The pronunciation prediction training module 210 may extract pronunciation information corresponding to the text corpus stored in the text vowel reduction corpus DB 50, in which vowel reductions are labeled, from the pronunciation dictionary DB 20. Here, the pronunciation selected from the pronunciation dictionary DB 20 may be referred to as canonical phonemes.

The pronunciation dictionary DB 20 may be a data base in which actual pronunciations for respective words are matched to international phonetic alphabets (IPA) or symbols such as ARPAbet, SAMPA, etc.

The stress prediction training module 220 may predict stresses for respective words in the text by analyzing the text. The stresses may be predicted by calculating probabilities that stresses are given to the respective words. That is, the stress prediction training module 220 may perform the same role as that of the stress prediction module 120.

The vowel reduction prediction training module 230 may store a distribution or a weight of a probability that a vowel reduction exists in the text, which is generated through the machine-based learning using the text characteristics information, which is extracted from the pronunciation prediction training module 210 and the stress prediction training module 220, for predicting vowel reductions as training data, in the vowel reduction prediction model DB 10.

That is, a relation between the text characteristics information for predicting vowel reduction and the vowel reduction may be calculated as a probability, and the calculated probability may be stored in the vowel reduction prediction model DB 10 as corresponding to respective text characteristics information.

Therefore, the text characteristics information may be extracted from the text vowel reduction corpus DB 50 in which vowel reductions are labeled, and a distribution and a weight of a probability that a vowel reduction occurs may be calculated through the machine-based learning using the extracted text characteristics information as training data whereby information on the distribution and the weight of the probability may be stored in the vowel reduction prediction model DB 10.

FIG. 3 is a block diagram of a vowel reduction detection model DB according to an exemplary embodiment.

Referring to FIG. 3, a vowel reduction detection model DB 30 according to an exemplary embodiment may be constructed by the vowel reduction detection training unit 400. Thus, the apparatus for learning vowel reduction according to an exemplary embodiment may further comprise the vowel reduction detection training unit 400.

The vowel reduction detection training unit 400 may recognize pronunciations from text corpuses where vowel reductions are labeled, which are stored in a speech vowel reduction corpus DB 60, by using the text vowel reduction corpus DB 50, detect stresses, and extract the speech characteristics information for predicting vowel reduction. Also, the vowel reduction detection training unit 400 may store a distribution or a weight of a probability that a vowel reduction exists in a generated speech, through the machine-based learning using the extracted speech characteristics information as training data, in the vowel reduction detection model DB 30.

The vowel reduction detection training unit 400 may comprise a pronunciation recognition training module 410, a stress detection training module 420, and a vowel reduction detection training module 430.

The pronunciation recognition training module 410 may recognize a provided speech to generate corresponding pronunciation phonemes. The pronunciation generated by recognizing the provided speech may be referred to as actual phonemes.

The pronunciation recognition training module 410 may use the extended pronunciation dictionary DB 40 when generating the actual phonemes. The extended pronunciation dictionary DB 40 may be a database including various pronunciations such as substituent pronunciations for a word as well as regular phonemes. For example, a reference pronunciation for a word ‘only’ may be ‘/ow n l iy/’ as ARPAbet. However, ‘/ah n l iy/’, ‘/ah ng l iy/’, and ‘/ow l l iy/’ may be stored in the extended pronunciation dictionary DB 40 as error pronunciations possible for Korean.

The stress detection training module 420 may detect stresses of respective words included in a provided speech by analyzing the provided speech. The stresses may be detected by calculating probabilities that stresses exist in respective words.

The vowel reduction detection training module 430 may receive information on actual phonemes for detecting stresses of respective words extracted by the pronunciation recognition training module 410 and stress information (a probability that a stress is given to the corresponding word) for detecting vowel reductions of respective words extracted by the stress detection training module 420, and store a distribution and a weight of a probability that a vowel reduction exists in a generated speech, which is calculated through the machine-based learning using the stress information as training data, in the vowel reduction detection DB.

That is, a relation between the detected pronunciation and the stress information and the vowel reduction may be calculated as a probability by using the detected pronunciation for detecting vowel reductions extracted from the pronunciation recognition training module 410 and the stress information for detecting stresses extracted from the stress detection training module 420, and the calculated probability may be stored in the vowel reduction detection model DB 30 as mapped to the detected pronunciation and the stress information.

Therefore, the text characteristics information may be extracted from the speech vowel reduction corpus DB 60 in which vowel reductions are labeled, and a distribution and a weight of a probability that a vowel reduction occurs may be calculated through the machine-based learning using the extracted text characteristics information as training data whereby information on the distribution and the weight of the probability may be stored in the vowel reduction detection model DB 30.

Although respective components of the apparatus for learning vowel reductions according to an exemplary embodiment are explained as separate components, at least two of the components may be aggregated into a single component, or a single component may be separated into two entities for performing the identical functions. The various modification and changes may be made without departing from the spirit and scope of the inventive concept as defined in the appended claims and their equivalents.

Also, the apparatus for learning vowel reductions may be implemented as program codes recorded in a computer-readable medium, which can be executed by a computer. The computer-readable medium may include various kinds of recoding mediums on which computer-readable data are recorded. Also, the recoding medium may be distributed over computer systems connected through a network, and the program codes may be stored and executed in distributive manner.

FIG. 4 is a conceptual diagram to explain provision of vowel reduction difference information according to an exemplary embodiment of the present disclosure.

Referring to FIG. 4, the vowel reduction predicted based on the provided text may be compared with the vowel reduction detected from the user speech corresponding to the provide text. Also, the differences between the predicted vowel reductions and the detected vowel reductions may be identified, and certainty information on vowels for which the differences exist (e.g., fo'r) may be derived.

For example, when a predetermined threshold is 90%, vowel reduction difference information for a first word ‘for’ whose certainty level is equal to or greater than 90% may be provided to the user as feedback. On the contrary, vowel reduction information for a second word ‘your’ and a fourth word ‘for’ whose certainty levels are less than 90% may not be provided to the user.

That is, only vowel reduction difference information whose certainty level is equal to or greater than 90% (the predetermined threshold) may be provided to the user.

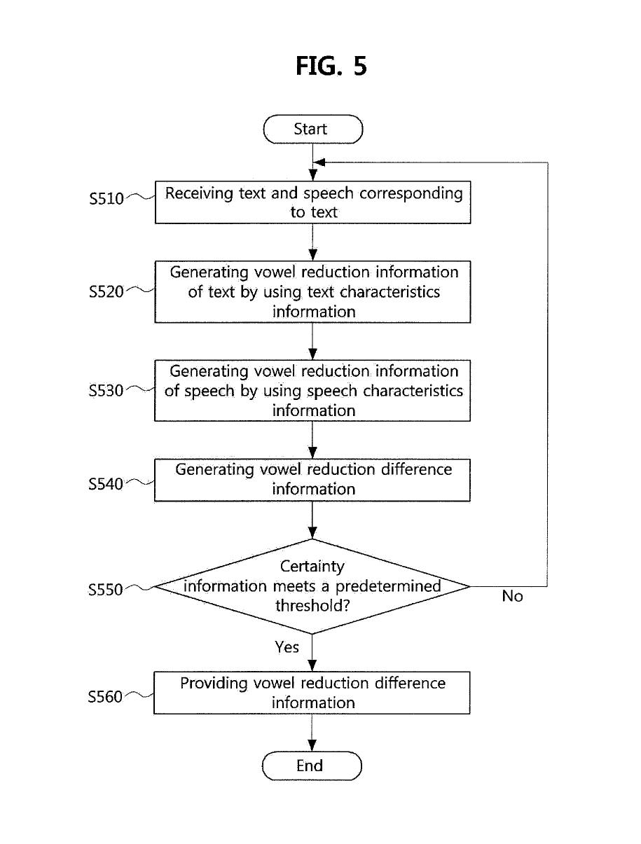

FIG. 5 is a flow chart to explain a method for learning vowel reductions according to an exemplary embodiment of the present disclosure.

Referring to FIG. 5, the method for learning vowel reductions according to an exemplary embodiment may be executed by the above-described apparatus for learning vowel reductions.

A text and a user speech corresponding to the text may be provided (S510).

The text characteristics information including predicted pronunciation of words included in the text and predicted stress information may be extracted through prediction on the text, and the vowel reduction information of the text may be generated based on the pre-saved model DB 10 by using the text characteristics information (S520). Also, the predicted pronunciation may be generated by predicting pronunciation of words included in the text based on the pronunciation dictionary DB 20, and the predicted stress information may be generated by predicting stresses of words included in the text. Therefore, prediction information corresponding to the text characteristics information may be obtained from the pre-saved vowel reduction prediction model DB 10, and the vowel reduction information of the text may be generated by using the obtained prediction information.

The speech characteristics information including detected pronunciation and detected stress information may be extracted through analysis on the user speech corresponding to the text, and the vowel reduction of the speech may be generated based on the pre-saved vowel reduction detection model DB 30 by using the speech characteristics information (S530). The detected pronunciation may be generated by detecting actual phonemes for the user speech based on the extended pronunciation dictionary DB 40, and the detected stress information may be generated by detecting stresses of the words included in the user speech. Accordingly, the detection information corresponding to the speech characteristics information may be obtained from the pre-saved vowel reduction detection model DB 30, and the vowel reduction information of the speech may be generated by using the obtained detection information.

The vowel reduction difference information may be generated by comparing the vowel reduction information of the text and the vowel reduction information of the speech (S540).

The certainty information of the vowel reduction difference information may be generated, and it may be determined whether the certainty information meets a predetermined threshold or not (S550). Therefore, only when the certainty information meets the predetermined threshold, the vowel reduction difference information may be provided to the user (S560).

Also, the certainty information may be generated by summing a probability according to the vowel reduction information of the text and a probability according to the vowel reduction information of the speech, respective weights being applied to the probabilities.

That is, the certainty information may be generated for maintaining reliability of feedback. The certainty information may be controlled to be provided to the user only when the certainty level meets the predetermined threshold so that the user can have reliability on the feedback.

The apparatus and method for learning vowel reduction according to the above-described exemplary embodiments may compare correct vowel reductions of a provided text and vowel reductions included in a user speech corresponding to the provided text, and support efficient foreign language learning of the user by providing the user with information corresponding to a difference between the correct vowel reductions of the text and the vowel reductions included in the user speech.

Also, the information corresponding to the difference may be provided based on certainty of the information thereby increasing the reliability of the information.

While exemplary embodiments have been described above in detail, it should be understood that various modification and changes may be made without departing from the spirit and scope of the inventive concept as defined in the appended claims and their equivalents.

1. An apparatus for learning vowel reduction, the apparatus comprising:
a vowel reduction predicting unit extracting text characteristics information including predicted pronunciation and predicted stress information related to words in a text through prediction on the text, and generating vowel reduction information of the text based on a pre-saved vowel reduction prediction model database (DB), by using the text characteristics information;
a vowel reduction detection unit extracting speech characteristics information including detected pronunciation and detected stress information based on an analysis on a speech of a user corresponding to the text, and generating vowel reduction information of the speech based on a pre-saved vowel reduction detection model DB, by using the speech characteristics information; and
a vowel reduction feedback unit generating vowel reduction difference information by comparing the vowel reduction information of the text and the vowel reduction information of the speech.

2. The apparatus according to claim 1, wherein the vowel reduction predicting unit comprises:
a pronunciation prediction module generating the predicted pronunciation by predicting pronunciation of words included in the text based on a pronunciation dictionary DB; and
a stress prediction module generating the predicted stress information by predicting stresses of words included in the text.

3. The apparatus according to claim 2, wherein the vowel reduction predicting unit further comprises a vowel reduction prediction module obtaining prediction information corresponding to the text characteristics information from the pre-saved vowel reduction prediction model DB, and generating the vowel reduction information of the text by using the obtained prediction information.

4. The apparatus according to claim 1, wherein the vowel reduction detection unit comprises:
a pronunciation recognition module generating the detected pronunciation by detecting actual phonemes of the speech of the user based on an extended pronunciation dictionary DB; and
a stress detection module generating the detected stress information by detecting stresses of words included in the speech of the user.

5. The apparatus according to claim 4, wherein the vowel reduction detection unit further comprises a vowel reduction detection module obtaining detection information corresponding to the speech characteristics information from the pre-saved vowel reduction detection model DB, and generating the vowel reduction information of the speech by using the obtained detection information.

6. The apparatus according to claim 1, wherein the vowel reduction feedback unit comprises:
a vowel reduction comparison module generating vowel reduction difference information by comparing the vowel reduction information of the text and the vowel reduction information of the speech; and
a vowel reduction feedback module generating certainty information of the vowel reduction difference information, and providing the vowel reduction difference information when the certainty information meets a predetermined threshold.

7. The apparatus according to claim 6, wherein the vowel reduction feedback module generates the certainty information by summing a probability according to the vowel reduction information of the text and a probability according to the vowel reduction information of the speech, respective weights being applied to the probabilities.

8. The apparatus according to claim 1, wherein the text characteristics information is extracted from a text vowel reduction corpus DB in which vowel reductions are labeled, and a distribution and a weight of a probability that a vowel reduction occurs are stored in the pre-saved vowel reduction prediction model DB through a machine-based learning using the text characteristics information as training data.

9. The apparatus according to claim 1, wherein the speech characteristics information is extracted from a speech vowel reduction corpus DB in which vowel reductions are labeled, and a distribution and a weight of a probability that a vowel reduction occurs are stored in the pre-saved vowel reduction prediction model DB through a machine-based learning using the text characteristics information as training data.

10. A method for learning vowel reduction, the method comprising:
extracting text characteristics information including predicted pronunciation and predicted stress information related to words in a text through prediction on the text, and generating vowel reduction information of the text based on a pre-saved vowel reduction prediction model database (DB), by using the text characteristics information;
extracting speech characteristics information including detected pronunciation and detected stress information based on an analysis on a speech of a user corresponding to the text, and generating speech vowel reduction information of the speech based on a pre-saved vowel reduction detection model DB, by using the speech characteristics information; and
generating and providing vowel reduction difference information by comparing the vowel reduction information of the text and the vowel reduction information of the speech.

11. The method according to claim 10, wherein the generating the vowel reduction information of the text comprises:
generating the predicted pronunciation by predicting pronunciation of words included in the text based on a pronunciation dictionary DB; and
generating the predicted stress information by predicting stresses of words included in the text.

12. The method according to claim 10, wherein the generating the vowel reduction information of the text further comprises obtaining prediction information corresponding to the text characteristics information from the pre-saved vowel reduction prediction model DB, and generating the vowel reduction information of the text by using the obtained prediction information.

13. The method according to claim 10, wherein the generating the vowel reduction information of the speech comprises:
generating the detected pronunciation by detecting actual phonemes of the speech of the user based on an extended pronunciation dictionary DB; and
generating the detected stress information by detecting stresses of words included in the speech of the user.

14. The method according to claim 13, wherein the generating the vowel reduction information of the speech further comprises obtaining detection information corresponding to the speech characteristics information from the pre-saved vowel reduction detection model DB, and generating the vowel reduction information of the speech by using the obtained detection information.

15. The method according to claim 10, wherein the generating and providing vowel reduction difference information comprises:
generating vowel reduction difference information by comparing the vowel reduction information of the text and the vowel reduction information of the speech; and
generating certainty information of the vowel reduction difference information, and providing the vowel reduction difference information when the certainty information meets a predetermined threshold.

16. The method according to claim 15, wherein the certainty information is generated by summing a probability according to the vowel reduction information of the text and a probability according to the vowel reduction information of the speech, respective weights being applied to the probabilities.
